(19) United States
(12) Patent Application Publication
(10) Pub. No.: US 2008/0201182 A1
(43) Pub. Date: Aug. 21, 2008

(54) Method for determining an aggregated forecast deviation

(76) Inventors: Welf Schneider, Karlsruhe (DE); Jochen Schabinger, Muehlacker-Enzberg (DE); Ulrike Albrecht, Aulendorf (DE); Heike Suthaus, Walzbachtal-Joehlingen (DE)

Correspondence Address: KENYON & KENYON LLP, ONE BROADWAY, NEW YORK, NY, 10004, US

(21) Appl. No.: 11/796,365

(22) Filed: Apr. 27, 2007

(30) Foreign Application Priority Data
May 2, 2006 (DE) 102006020175.2

(51) Int. Cl. G06Q 10/00

(52) U.S. Cl. 705/7; 705/1

(57) ABSTRACT

In the method for determining an aggregated forecast deviation, deviations are aggregated in a predefined environment at all reference points in time and are incorporated into an error determination. Using this method, the aggregated forecast deviation for a product is determinable so that this product may be made available in a sufficient quantity. The method is thus suitable, e.g., for disposition planning, warehouse management, or warehousing products of all types.

### FIELD OF THE INVENTION

The present invention relates to a method for determining an aggregated forecast deviation, a method for selecting a forecast, a device for determining an aggregated forecast deviation, a computer program, and a computer program product.

### BACKGROUND INFORMATION

The forecast error measures are usually referred to by the terms “aggregated forecast deviation” (AFD) and “relative aggregated forecast deviation” (RAFD). For mathematical forecasts, e.g., for a demand for an object or product, the quality of the forecast is usually evaluated by ex-post forecasts using an error measure based on consumption series or histories of the object from the past. Known error measures include the mean absolute deviation (MAD), the error total (ET), the mean absolute percentage error (MAPE), the mean square error (MSE), the square root of the mean square error (RMSE), the mean percentage error (MPE), etc.

For measuring the quality of a forecast, the historical values of the object to be predicted are usually compared with ex-post forecast values, usually ascertained via forecasting methods, for a comparative period of time. The error measure is used for the comparison. Traditional error measures and/or functions are usually based on a direct comparison between the historical value and the ex-post forecast value for the same period or the same time frame.

### SUMMARY OF THE INVENTION

With the method according to the present invention for determining an aggregated forecast deviation, deviations are aggregated, i.e., accumulated or assembled in a predefined environment at all reference points in time and are included in an error determination.

In performing the method, an aggregation may be performed for deviations at all comparative points in time of the predefined environment, for example, in an interval of time, i.e., in an observation period of time. For example, several forecasts may be provided for the trend in inventory of a given product. When performing the method, deviations or differences between predicted forecast values of each forecast and actually occurring actual values of an inventory trend for the product are formed via aggregation at all periods or points in time within the predefined environment. These deviations may be added up for aggregation for each individual forecast. Thus a forecast deviation may be provided for each forecast, in particular ex-post forecast.

In one embodiment, a profile range of a forecast curve formed from the forecast values and a historical curve formed from the actual values may be compared for each period to provide an error value and thus the particular deviation of a forecast value of one of the forecasts from an actual value in the predefined environment. For such a comparison, deviations may be ascertained between the forecast curve and the historical curve and then added up. The historical curve and forecast curve usually include discretely distributed points which are assigned to discretely distributed periods and/or points in time. The actual values of the historical curve are thus acquired at periodically recurring points in time; accordingly the forecast values are calculated for periodically recurring points in time.

A forecasting method may be adjusted using this method. This may mean that variable parameters of an algorithm of a forecasting method to be adjusted may be modified and thus adjusted and/or calibrated. An adjustment may be performed in such a way that the aggregated forecast deviation for the forecasting method is minimal.

The present invention also relates to a method for selecting an optimal forecast from a number of forecasts. To do so, the method according to the present invention is taken into account for determining an aggregated forecast deviation in which deviations are aggregated in a predefined environment at all reference points in time and are included in an error determination for the forecast. The selection is made by taking into account the aggregated forecast deviation.

In one embodiment, a forecasting method suitable for a product is determined using the aggregated forecast deviation, so that new forecasts may be created for this product using the forecasting method determined in this way. The product may thus be supplied in an adequate quantity.

Forecasts are usually ascertained for the product by using multiple forecasting methods. With the present invention, a tool is now available for determining a quality of the forecasting method. For each forecasting method, the aggregated forecast deviation is determined. The forecasting methods may be compared with one another, taking into account the aggregated forecast deviations, so that at least one optimal forecast in this regard, which thus has a particularly low aggregated forecast deviation and thus supplies good forecast values, may be determined.

Using this method for selecting an optimal forecast, a forecast for a product may be determined using the aggregated forecast deviation, so that this product may be provided in an optimal quantity, taking into account the selected forecast.

The present invention also relates to a device for determining an aggregated forecast deviation. This device is designed to aggregate deviations in a predefined environment at all reference points in time and to include them in an error determination.

The device according to the present invention is designed to execute all steps of at least one of the methods according to the present invention.

This device according to the present invention may have at least one module suitable for performing the method, designed in particular as a computing device. The device is designed in one embodiment to determine the aggregated forecast deviation for a product and thus to ensure that this product may be provided in an optimal amount, e.g., as part of disposition planning. On the basis of the aggregated forecast deviation, the device is able to determine at least one forecasting method favorable for the product. In addition, the device may cooperate with at least one logistic device and may influence a function of this at least one device through control and/or regulation, for example. Furthermore, the device may also be designed to provide the product.

The present invention also relates to a computer program having a program code means to perform all the steps of a method according to the present invention when the computer program is executed on a computer or a corresponding computing unit, in particular of a device according to the present invention.

The device also relates to a computer program product have program code means stored on a computer-readable data medium to perform all the steps of a method according to the present invention when the computer program is executed on a computer or corresponding computing unit, in particular of a device according to the present invention.

In the execution of the method for providing the aggregated error measure (aggregated forecast deviation, abbreviated AFD) or the relative aggregated error measure (RAFD) and thus also the relative aggregated forecast deviation in particular, the error measure is based not only on a direct comparison between the historical value and the ex-post forecast value. To provide the error measure, a deviation is aggregated in a compensatory manner in a predefined environment in particular and then incorporated into the error determination.

It is thus possible through the compensatory evaluation of forecast deviations in the predefined environment (ex-post forecast) to calculate deviations within the environment.

This method may be advantageously used for warehouse disposition planning and also for predictive warehouse management; it is thus possible to determine a future demand for a product and/or a forecast object and thus ensure reliably and in the long term that the forecast object will be kept on hand in a sufficient quantity. As a predictive, i.e., forecast, profile more closely approaches the real demand structure, this improves the planning for an inventory adjustment for the forecast object. One fact that must be taken into account here is that in orders for the forecast object, there is a time delay until receipt of the goods, sometimes lasting for several periods. With the present invention, this may be taken into account for at least one profile range up to all profile ranges and/or reference points in time.

In the execution of the method, an AFD and/or RAFD error measure is thus calculated for the ex-post forecasts. When application of the method is possible, a forecasting method may be adjusted.

An empirical analysis of the method has shown that the new aggregated error measure is particularly suitable for adjusting inventory. To this end, an ex-post analysis of a representative selection of 350 articles was performed for the needs of a pool warehouse. Forecasting methods that are calibrated using the error measure according to the aggregated forecast deviation or relative aggregated forecast deviation achieve significantly better inventory adjustments than other procedures.

To execute the present invention, the mathematical notations and definitions described below are used in an embodiment.

Let it be assumed that a sales history H of a forecast object is given over time frame t=1, . . . , S, where S∈IN: H=(h₁, h₂, . . . , hₛ), where hₜ∈IR for sales of the forecast object in the period t. ƒₜ∈IR is the forecast value for the periods t=1, 2, . . . , S. In addition, an observation period of length V is provided via indices t=t₀+1, . . . , t₀+V−1, where V≦S and t₀+V−1≦S.

The following holds for initializing the calculation of error measure AFD:

baₜ_{₀}=ƒₜ_{₀}−hₜ_{₀}

and for the computation method

baₜ=baₜ₋₁+ƒₜ−hₜ, where t=t₀+1, . . . , t₀+V−1.

For the (average) aggregated forecast deviation AFD^{V} and/or the (averaged) aggregated forecast, it holds:

$${AFD}^{V} = \frac{1}{V} \cdot {\sum }_{t = {t}_{0}}^{{t}_{0} + V - 1} \vert {ba}_{t} \vert$$

Relativizing aggregated forecast deviation AFD^{V} to the entire history in observation period t=t₀+1, . . . , t₀+V−1 yields the relative (averaged) aggregated forecast deviation and/or relative averaged aggregated forecast deviation RAFD^{V}:

$${RAFD}^{V} = \frac{\frac{1}{V} \cdot {\sum }_{t = {t}_{0}}^{{t}_{0} + V - 1} \vert {ba}_{t} \vert}{\frac{1}{V} \cdot {\sum }_{t = {t}_{0}}^{{t}_{0} + V - 1} {h}_{t}} = \frac{{\sum }_{t = {t}_{0}}^{{t}_{0} + V - 1} \vert {ba}_{t} \vert}{{\sum }_{t = {t}_{0}}^{{t}_{0} + V - 1} {h}_{t}}$$

Alternatively, it is also conceivable to use established procedures. However, no profile adjustment is possible then in the ex-post forecast and thus no adjustment for disposition of inventory taking into account the order time is possible. In concrete applications, established procedures yield forecast results that are significantly inferior to those obtained by the method according to the present invention.

An embodiment for a development of the aggregated forecast deviation and the relative aggregated forecast deviation derivable therefrom is depicted in Table 1 below. Table 1 shows historical values and/or consumption values for a product in the respective periods for five periods, i.e., points in time 1 through 5. Historical values, i.e., consumption values, are given for the product in the particular periods. In addition, forecast values from ex-post forecasts and their deviations from the historical values are given for three predefined environments, each including three periods. The fact that the forecast values for the same periods may differ from one environment to the next may be due to a forecast being adapted by adjusting parameter values from one environment to the next or due to the integration of new historical values into the forecast calculation being performed. The individual forecasts and thus the deviations are determined here ex-post, i.e., subsequently as soon as the historical values and/or actual values are available.

TABLE 1

| Period | 1 | 2 | 3 | 4 | 5 |
|---|---|---|---|---|---|
| Historical values | 10 | 20 | 15 | 18 | 18 |
| Ex-post forecast, first environment | 15 | 15 | 20 | | |
| Deviation | +5 | −5 | +5 | | |
| Ex-post forecast, second | | 18 | 18 | 20 | |
| environment | | | | | |
| Deviation | | −2 | +3 | +2 | |
| Ex-post forecast, third | | | 18 | 19 | 20 |
| environment | | | | | |
| Deviation | | | 0 | +1 | +2 |

To determine the aggregated forecast deviation, the deviations are aggregated and included in an error determination within the predefined environment, which includes three periods here, in all periods and thus at all reference points in time. In a particular embodiment of the present invention, the deviations are added up in a suitable manner for each environment.

It is possible to determine the aggregated forecast deviations for several available forecasting methods with this product, compare them with one another and supply an optimal forecasting method for the product therefrom.

### BRIEF DESCRIPTION OF THE DRAWINGS

FIG. 1 schematically shows an exemplary diagram of an ex-post analysis.

FIG. 2 schematically shows an embodiment of a device according to the present invention.

### DETAILED DESCRIPTION

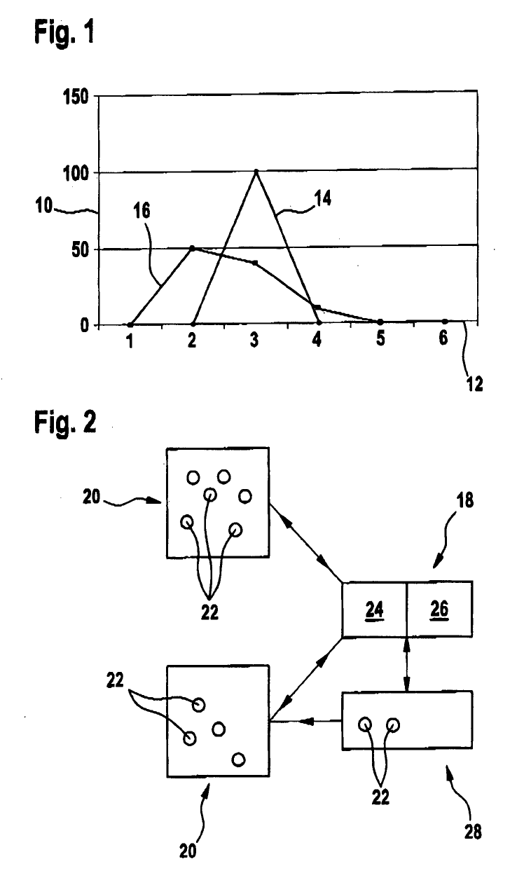

The diagram in FIG. 1 shows the data from Table 2.

TABLE 2

| Period i | 1 | 2 | 3 | 4 | 5 | 6 |
|---|---|---|---|---|---|---|
| History hᵢ | 0 | 0 | 100 | 0 | 0 | 0 |
| Forecast fᵢ | 0 | 50 | 40 | 10 | 0 | 0 |

The values for the units are plotted on a vertical axis 10 over a horizontal axis 12 for the values of the period. The values for history hᵢ, in this case a demand for a product, are linked together by a history curve 14; the values for forecast fᵢ and thus for a prediction are linked together via a forecast curve 16.

In traditional procedures, a history is usually compared with an ex-post forecast value for each period.

With the method according to the present invention, in a new forecast deviation AFD and thus a new error measure for each period i, a profile range between forecast curve 16 and history curve 14 is compared as an error value. Profile ranges in which forecast curve 16 is situated above history curve 14 are evaluated as positive. Profile ranges in which forecast curve 16 is below history curve 14 are evaluated as negative.

Relation of forecast deviation AFD to the overall history of the observation period yields the relative aggregated forecast deviation (RAFD).

FIG. 2 shows a schematic diagram of a device 18 and a warehouse 20 designed for storing a quantity of a product 22. At a first reference point in time in the past, there are six items of product 22 in warehouse 20; at a second reference point in time in the future, there will be four items of product 22 in warehouse 20. The quantity of product 22 changes according to demand by removal of individual products 22; warehouse 20 is restocked by adding products 22.

Device 18 is designed for determining an aggregated forecast deviation for product 22 to aggregate deviations at all reference points in time in a predefined environment and incorporate them into an error determination.

In the present embodiment, device 18 has a plurality of forecasts for product 22. Each forecast is supplied by a forecasting method. By performing the method, it is possible to ascertain the aggregated forecast deviation for all forecasts in the predefined environment.

Taking into account all aggregated forecast deviations, it is possible to compare the forecasts with one another and thus ascertain favorable forecasting methods for the product. It is also possible to optimize individual forecasting methods against the background of aggregated forecast deviations by adjusting parameters. Device 18 thus contributes toward this product 18 being present in an optimal quantity in warehouse 20 by determination of favorable forecasting methods.

To do so, device 18 has two modules 24, 26. A first module 24 is designed to cooperate with warehouse 20 and to determine the quantity of product 22 at the first reference point in time from the past. A second module 26 is designed as the computing device. With this computing device, a demand for product 22 at the second reference point in time is calculated, taking into account all the first reference points in time. It is thus possible to predict the addition of product 18 in a timely manner, so that an optimal quantity of product 18 is always to be found in warehouse 20. For regulation of quantity, it is provided that device 18 cooperates with a logistic device 28 and controls this device 28 in such a way that device 28 promptly adds product 18 in a sufficient quantity to warehouse 20.

What is claimed is:

1. A method for determining an aggregated forecast deviation, comprising:
aggregating deviations in a predefined environment at all reference points in time; and
incorporating the deviations into an error determination.

2. The method according to claim 1, further comprising determining a relative aggregated forecast deviation by relativizing an aggregated forecast deviation with respect to an overall history of an observation period of time.

3. The method according to claim 1, wherein the deviations are aggregated in a compensatory manner.

4. The method according to claim 1, further comprising comparing a profile area between a forecast curve and a historical curve for each period to provide an error value.

5. The method according to claim 1, further comprising calculating a forecast deviation for at least one ex-post forecast.

6. The method according to claim 1, further comprising adjusting a forecasting method.

7. A method for selecting a forecast from a number of forecasts, comprising:
selecting the forecast by taking into account an aggregated forecast deviation which is determined by aggregating deviations in a predefined environment at all reference points in time and incorporating the deviations into an error determination.

8. The method according to claim 7, further comprising determining a forecasting method suitable for a product using the aggregated forecast deviation in such a way that the product is provided in an optimum quantity by using the determined forecasting method.

9. A device for determining an aggregated forecast deviation, comprising:
an arrangement for aggregating deviations at all reference points in time in a predefined environment; and
an arrangement for incorporating the deviations into an error determination.

10. The device according to claim 9, further comprising an arrangement for determining a forecasting method suitable for a product via the aggregated forecast deviation to ensure that the product is suppliable in a sufficient quantity.

11. A computer-readable medium containing a computer program which when executed by a processor performs the following method for determining an aggregated forecast deviation:
aggregating deviations in a predefined environment at all reference points in time; and
incorporating the deviations into an error determination.
